(19) United States
(12) Patent Application Publication
(10) Pub. No.: US 2005/0250620 A1
(43) Pub. Date: Nov. 10, 2005

(54) Therapeutic color changing putty and method of therapeutic exercise using same

(75) Inventors: Maurice Gregory Minuto, Smithtown, NY (US); David Woodbury Bean, Smithtown, NY (US)

Correspondence Address: James W. Badie, Esq.;Stoll, Miskin & Badie, The Empire State Building, 350 Fifth Avenue, Suite 4710, New York, NY, 10118, US

(73) Assignee: Depco, Inc.

(21) Appl. No.: 11/182,479

(22) Filed: Jul. 15, 2005

Related U.S. Application Data
(63) Continuation-in-part of application No. 10/267,087, filed on Oct. 9, 2002.

(51) Int. Cl. G21F 1/10

(52) U.S. Cl. 482/49

(57) ABSTRACT

A color changing putty is provided for therapeutic exercise, comprising a silicone putty and a pigment such that when the putty is worked by the hands, the pigmented putty gives visual indication of color change after a certain length of time depending on the amount of the putty, the firmness of the putty, and the type of pigment used in the putty. A therapeutic exercise method is also provided using the color changing putty.

### RELATED APPLICATIONS

This application is a continuation-in-part application of pending application Ser. No. 10/267,087 filed Oct. 9, 2002.

### FIELD OF THE INVENTION

The present invention relates to color changing putty and, in particular, to silicone putty containing a pigment which will cause a change in color of the putty due to application of heat, such as when the putty is manipulated by the hands during therapeutic exercise. This invention also relates to a method of therapeutic exercise using color changing silicone putty.

### BACKGROUND OF THE INVENTION

Color changing putties, including color changing silicone putties have been known and used for various purposes. For example, U.S. Pat. No. 5,786,578 issued to George M. Christy et al. on Jul. 28, 1998 describes a microwave-heatable therapeutic exercise putty mass packaged within a container having a transparent wall. A thermochromic heat sensitive semiconductor is affixed to the container wall in intimate heat transfer contact with the putty. The thermochromic material provides visual indications through the wall when the putty reaches certain temperatures. The putties disclosed in the aforementioned patent include organopolysiloxane-boron bouncing putties.

Another patent, i.e., U.S. Pat. No. 5,596,025 issued to Joe D. Oxman et al. discloses a dental impression material in which the cure can be monitored visually. The material comprises a silicone polymer and one or more cure-indicating dyes which impart to the composition an initial pre-cure color and a different color after the composition reaches its cure temperature.

U.S. Pat. No. 5,446,075 issued to Robert M. Gibbons on Aug. 29, 1995 describes a method and apparatus for monitoring a patient's progress in manipulative therapy by using an exercise putty. Two different colored masses of putty are supplied to the patient who is instructed to knead or manipulate the two putties together until the mixture of the putty mass achieves a uniform color. The exercise putties used in the method of said patent include a chain extended polysiloxane reaction product and, optionally, normal polysiloxane gum.

An article by While et al. titled “A Serious Look At Changeable Silly Putty”, published in The Chemical Educator, Vol. 5, No. 1 (2000) describes color changing putty made by mixing silicone putty with a thermochromic pigment. This article does not disclose the use of pigmented putties for therapeutic exercise nor does it disclose the inter-relationship of putty firmness, time, temperature, nature of the pigment and the amount of the pigmented putty.

Notwithstanding the putties described in the aforementioned patents, there is still a dire need for a simple, economical and effective color changing putty for use in therapeutic exercise.

Accordingly, it is object of the present invention to provide an exercise putty for use in therapeutic applications.

It is a further object of this invention to provide a therapeutic exercise putty which is capable of providing a visual indication of a change in color of the putty after the putty has achieved a certain temperature.

It is also an object of this invention to provide an exercise pigmented putty which exhibits a visual change in color depending on the firmness of the putty, duration of exercise, temperature and nature of the pigment and the amount of the pigmented putty.

It is a further object of this invention to provide a therapeutic exercise method using such color changing putties.

The foregoing and other objects and features of the present invention will be better understood from the ensuing detailed description.

### SUMMARY OF THE INVENTION

The invention provides a pigmented putty for therapeutic exercise wherein the duration of the exercise is determined by visual change in color of the initial pigmented putty. The change in color is noticed after a certain elapsed exercise time depending on the quantity of putty used, its firmness and the type of pigment used with the putty. An example of color changing putty comprises a bouncing putty known as Q2-3232 described in U.S. Pat. No. 5,607,993 issued Mar. 14, 1997 to Michael Christy and assigned to Dow Corning. A particularly useful pigment is available from Matsui Shikiso Chemical Co., Ltd. Kyoto, Japan, as Matsui Color C-22, C-25 and C-35. Generally from about 0.5 to about 6 parts of the pigment are used with the putty and imparts a blue color to the pigmented putty which, after the therapeutic exercise for a specified time changes color to light blue. After termination of the exercise, the light blue pigmented putty reverts to its initial more intense blue color in approximately 60 minutes.

### DETAILED DESCRIPTION OF THE INVENTION

In accordance with this invention, when certain pigments are incorporated into a putty, such as bouncing putty or exercise putty, and the putty is used for therapeutic purpose, such as working it by the hands, the putty exhibits a change in color due to increase in its temperature, which depends on the firmness of the putty, the type of pigment used in the putty, the amount of the pigmented putty used and the duration of the exercise. This change in color provides the therapist with visual indication regarding the extent to which the patient has pursued the prescribed therapeutic regime. While not wishing to be bound by any particular theory, it is believed that when the pigment-containing putty of this invention is worked by the hands for therapeutic exercise, the heat generated by the hands causes a change in color of the pigmented putty. The color change is reversible, i.e.; the pigment-containing putty will change back to the color of the initial putty after discontinuing the therapeutic exercise. The color change depends on the firmness of the putty, the type of pigment, the amount of the putty and the duration of time required to reach the temperature at which the change in color becomes visible.

In addition to monitoring or confirming compliance with a prescribed therapeutic exercise program, there is advantageous biofeedback to the patient in that the patent is apprised of whether or not he or she is in compliance with the therapy depending on whether or not a color change is manifested by the putty. If no color change is observed, the patient is motivated to continue with the exercise regime until the color change is seen.

A useful color putty in accordance with this invention is a bouncing putty, exercise putty or a borosilicone compound together with a thermochromic pigment. One example of color changing putty comprises a bouncing putty base known as Q2-3233 available from Dow Corning as mentioned in U.S. Pat. No. 5,607,993 issued Mar. 14, 1997 in the name of Michael Christy. The bouncing putty described therein comprises a borosilicone rubber base with compatible lightweight additives such as density-reducing fillers. The bouncing putty may include a viscosity reducing agent such as, for example, polydimethylsiloxane, low molecular weight silanol and hydroxy-terminated polydialkylsiloxane. Also, certain borosilicone bouncing putties known as “Silly Putty” are useful because of their bouncing characteristics and other properties which make them well suited for use in physical therapy.

In order to achieve the desired visual indication of color change when used in therapeutic treatment, the thermochromic pigment is mixed with the putty in the usual manner to uniformly disperse the pigment in the putty and obtain a uniform color. One thermochromic pigment which can be beneficially used for the purpose of this invention is Matsui Color C-22 available from Matsui Shikiso Chemical Co., Ltd., Kyoto, Japan. A typical suitable formulation comprises 100 parts by weight of borosilicone rubber base such as Q2-3233, and about 0.5 to 6 parts by weight of the pigment. This pigment is available from Matsui in various colors, however, in the experiments described in the following table a blue pigment is used.

Other types of blue pigments available from Matsui are C-25 and C-35 which are also available in blue color and thus when mixed with the putty impart a blue color thereto.

A variety of silicone putties may be used for formulating the color changing putties of this invention for physical therapy treatment. These putties are described in the aforementioned patents, the disclosures of which are incorporated herein by reference. For the purpose of the present invention, they are referred to herein as silicone putty or silicone bouncing putty.

The inter-relationship of therapeutic exercise time to firmness of the putty, type of pigment used, the amount of pigmented putty and the final temperature of the putty are shown in the following tables. In the experiments conducted to determine said inter-relationship, the specific pigmented putty was manipulated by the hand until a change in color was observed. The elapsed time and the temperature at which such color change were observed were recorded, and the firmness of the putty was determined as well.

In all the experiments illustrated in the following tables, the amount of putty was measured in ounces (oz.), the elapsed time of working the putty was determined in minutes, the temperature of the putty before and after the elapsed time was measured in degrees Fahrenheit, and the initial firmness or plasticity of the putty was determined by ASTM Specification D.926-89 using the Williams Parallel Plate Plastimeter, and is expressed in standard Williams Plastimeter Units, i.e., millimeters×100. The putty used in all experiments was silicone putty from Dow Corning Company having the following formulation.

| Component | Wt. % | CAS Number |
|---|---|---|
| Hydroxy terminated dimethylsiloxane | 79 | 104780678 |
| containing 10% boric acid | | |
| Amorphous fumed silica | 15 | 007631863 |
| Glycerine | 2 | 000056815 |
| Polydimethylsiloxane | 4 | 063148629 |

The firmness of the putty may vary from about 80 to about 175, preferably from about 100 to 155.

The Williams Parallel Plate Plastimeter basically consists of two parallel metal plates, one secured at the base and the other made moveable directly above the bottom plate via a 360 degree vertical guide sleeve. When the upper platen is lowered, a force of 49+/−0.05N is applied to the specimen. A dial micrometer gauge is attached to the unit and measures thickness of the sample as it is compressed by the top platen. The plasticity number of the test specimen is the thickness of the specimen after a given time of compression by the top platen.

The test specimen is free of air pockets and has a volume of 2.00+/−0.02 cc. A cylinder 16 mm in diameter and 10 mm in height yields the necessary volume. These cylindrical dimensions represent the approximate shape of the sample that is tested.

The testing device and the samples were maintained at a temperature of approximately 72 degrees Fahrenheit for at least a 24-hour period. The plasticity number herein is the thickness in millimeters×100 after 3 minutes compression.

TABLE 1

| Sam- | Initial | Orig- | Pig- | | | | |
|---|---|---|---|---|---|---|---|
| ple | Putty | inal | ment | Time | Changed | Initial | Final |
| Size | Firmness | Color | Type | Worked | Color | Temp. | Temp. |
| 2 oz. | (soft) 118 | Blue | C 22 | 2:15 | White/ | 73 | 79 |
| | | | | | blue | | |
| 3 oz. | (soft) 118 | Blue | C 22 | 3:05 | White/ | 73 | 82 |
| | | | | | blue | | |
| 4 oz. | (soft) 118 | Blue | C 22 | 3:55 | White/ | 73 | 84 |
| | | | | | blue | | |

As seen from Table 1, the larger the quantity of the pigmented putty, the longer is the therapy time, and the higher is the final temperature at which the change in color is observed.

In the next series of experiments, the amount of pigmented putty was the same; using the same pigment but the putty firmness was varied. The results are shown in Table 2 below.

TABLE 2

| Sam- | Initial | Orig- | Pig- | | | | |
|---|---|---|---|---|---|---|---|
| ple | Putty | inal | ment | Time | Changed | Initial | Final |
| Size | Firmness | Color | Type | Worked | Color | Temp | Temp. |
| 2 oz. | (firm) 143 | Blue | C 22 | 3:05 | Lt/blue | 74 | 87 |
| 2 oz. | (medium) | Blue | C 22 | 2:50 | White/blue | 74 | 86 |
| | 133 | | | | | | |
| 2 oz. | (soft) 118 | Blue | C 22 | 2:15 | White/blue | 73 | 79 |

The results in Table 2 indicate that the firmer the putty the more time is needed to achieve the change in color signaling the length of the therapy period.

In the experiments shown in Table 3 below, different types of pigment were used while using the same amount of putty and the same putty firmness.

TABLE 3

| Sam- | Initial | | Pig- | | | | |
|---|---|---|---|---|---|---|---|
| ple | Putty | Original | ment | Time | Changed | Initial | Final |
| Size | Firmness | Color | Type | Worked | Color | Temp | Temp. |
| 2 oz. | (soft) 118 | Blue | C 22 | 2:15 | Lt/blue | 73 | 79 |
| 2 oz. | (soft) 118 | Blue | C 25 | 3:35 | Lt/blue | 73 | 86 |
| 2 oz. | (soft) 118 | Blue | C 35 | 12:00 | Lt/blue | 74 | 90 |

The results in Table 3 indicate that longer therapeutic time is required with certain pigments before a color change becomes visible. This is evident from comparing the time and temperature required when using C22, C25 and C35 in the putty.

After conclusion of the exercise, all pigmented putties described in the foregoing tables returned to the original blue color after approximately 60 minutes at room temperature. These putties are reusable for additional therapeutic exercise with the same efficiency as the original pigmented putties.

It is understood from the foregoing detailed description that other pigments can be used provided they can be uniformly blended with the putty and impart a different color to the pigmented putty, yet display a visual change in color after therapeutic exercise. Other changes and modifications are obvious without departing from the scope of the present invention.

1. A color changing putty useful for therapeutic exercise by manipulation by the hands comprising a predetermined amount of silicone putty having a firmness of from about 80 to about 175 as determined by ASTM Specification D-926.89 test, a pigment imparting a color A when mixed with said putty at room temperature and changes to a different color B after several minutes depending on the amount of said putty, the initial firmness of said putty and the pigment used with said putty.

2. A therapeutic exercise method comprising manipulating a predetermined amount of pigmented putty by hand, said pigmented putty having a firmness of from about 80 to 175 about as determined by ASTM Specification D-926.89 test, wherein said pigment in said putty has an initial color A, manipulating said pigmented putty for a length of time sufficient to change the color of said putty from its initial color A to a different color B, said time depending on the amount of said putty, the firmness of said putty and the pigment used with said putty.

3. A therapeutic exercise method as in claim 2 wherein said pigment constitutes from about 0.5 to about 6 parts by weight per 100 parts by weight of said putty.

4. A therapeutic exercise putty as in claim 2 wherein said putty is silicone bouncing putty.

5. A therapeutic exercise putty as in claim 3 wherein said putty is silicone bouncing putty.

6. A therapeutic exercise method as in claim 2 wherein said pigment is blue in color and the color of said pigmented putty changes from its initial blue color to light blue at the conclusion of said exercise.

7. A therapeutic exercise method as in claim 3 wherein said pigment is blue in color and the color of said pigmented putty changes from its initial blue color to light blue at the conclusion of said exercise.

8. A therapeutic exercise method as in claim 4 wherein said pigment is blue in color and the color of said pigmented putty changes from its initial blue color to light blue at the conclusion of said exercise.

9. A therapeutic exercise method as in claim 5 wherein said pigment is blue in color and the color of said pigmented putty changes from its initial blue color to light blue at the conclusion of said exercise.
